(19) United States
(12) Patent Application Publication
(10) Pub. No.: US 2021/0140928 A1
(43) Pub. Date: May 13, 2021

(54) RUBBING DETECTION DEVICE FOR ROTARY MACHINE AND METHOD FOR DETECTING RUBBING OF ROTARY MACHINE

(71) Applicant: MITSUBISHI HEAVY INDUSTRIES, LTD., Tokyo (JP)

(72) Inventors: Satoshi KUMAGAI, Tokyo (JP); Kunio ASAI, Tokyo (JP); Shuichi ISHIZAWA, Tokyo (JP); Ryo KAWABATA, Tokyo (JP)

(21) Appl. No.: 17/082,398

(22) Filed: Oct. 28, 2020

(30) Foreign Application Priority Data
Nov. 12, 2019 (JP) 2019-205008

(51) Int. Cl. G01N 29/14; G10L 25/51; H04R 3/04; G01N 29/44

(52) U.S. Cl. CPC G01N 29/14; G01N 29/4463; H04R 3/04; G10L 25/51

(57) ABSTRACT

A rubbing detection device for a rotary machine includes an AE sensor configured to acquire an AE signal of a rotary machine, an index calculation unit configured to calculate a rubbing detecting index for determining the presence or absence of rubbing based on information relating to a phase of the AE signal, and a determination unit configured to determine the presence or absence of rubbing based on the rubbing detecting index.

### CROSS-REFERENCE TO RELATED APPLICATIONS

This application claims the benefit of priority to Japanese Patent Application Number 2019-205008 filed on Nov. 12, 2019. The entire contents of the above-identified application are hereby incorporated by reference.

### TECHNICAL FIELD

The disclosure relates to a rubbing detection device for a rotary machine and a method for detecting rubbing of a rotary machine.

### RELATED ART

Rubbing of a rotary machine has been detected by detecting shaft vibration of a rotary shaft. In the rotary machine, rubbing occurs between a rotary shaft and a seal or other component due to thermal deformation of a casing. This rubbing generates heat, which causes thermal bending of the rotary shaft, thereby generating shaft vibration of the rotary shaft. Rubbing leads to an increase in shaft vibration and deterioration in sealing performance of the rotary machine. Thus, it is desirable to detect rubbing at an earlier stage.

JP 58-034326 A describes a rubbing detection device for a rotary machine. In this device, sound detecting sensors are attached to bearings disposed at either end of a rotary shaft of the rotary machine to detect high-frequency signals. These high-frequency signals obtained through detection are made to pass through a bandpass filter to extract a rubbing signal. The presence or absence of rubbing is identified, and a portion where rubbing occurs is detected based on a difference in phase between the individual high-frequency signals.

JP 63-179222 A describes a rubbing-location determining device in which, even when a phase difference between outputs from acoustic emission (AE) sensors attached to bearings of both ends of a rotary shaft of a rotary machine exceeds 180°, the position where rubbing occurs is determined by adding a comparison between magnitudes of amplitudes of individual outputs.

### SUMMARY

A steam turbine or other rotary machine deals with a large noise signal resulting from steam flow and so on. In such rotary machines, when amplitude of an AE signal of rubbing from an AE sensor is used as an index, the amplitude of the AE signal of rubbing is smaller than the amplitude of the noise signal resulting from steam flow and so on, and is hidden by the noise signal resulting from steam flow and so on. This leads to a problem in which the AE signal of rubbing cannot be detected.

The present disclosure has been made in view of the problem described above, and an object of the present disclosure is to provide a rubbing detection device for a rotary machine and a method for detecting rubbing of a rotary machine, which efficiently detect rubbing of a rotary machine with higher accuracy.

A means to solve the problem described above provides a rubbing detection device for a rotary machine, including an AE sensor configured to acquire an AE signal of the rotary machine, a calculation unit configured to calculate a rubbing detecting index based on information relating to a phase of the AE signal, and a determination unit configured to determine presence or absence of rubbing from the rubbing detecting index.

A means to solve the problem provides a method for detecting rubbing of a rotary machine, the method including the steps of acquiring an AE signal from a rotary machine, calculating a rubbing detecting index based on information relating to a phase of the AE signal, and determining presence or absence of rubbing in terms of the rubbing detecting index.

According to the disclosure, it is possible to detect rubbing of a rotary machine prior to the occurrence of shaft vibration of a rotating shaft, and also possible to efficiently detect rubbing of a rotary machine with high accuracy.

### BRIEF DESCRIPTION OF DRAWINGS

The disclosure will be described with reference to the accompanying drawings, wherein like numbers reference like elements.

FIG. 1 is a block diagram of a rubbing detection device for a rotary machine according to a first embodiment.

FIG. 2 is a graph showing amplitude of an AE signal according to the first embodiment for individual rotational orders.

FIG. 3 is a graph showing temporal distribution of a rubbing detecting index according to the first embodiment.

FIG. 4 is a graph showing cumulative probability of the rubbing detecting index according to the first embodiment.

FIG. 5 is a flowchart of a method for detecting rubbing according to the first embodiment.

FIG. 6 is a graph showing temporal change in amplitude of shaft vibration according to the first embodiment.

FIG. 7 is a graph showing temporal distribution of a first order component of rotational speed extraction phase of an AE signal that has been subjected to a filter process according to the first embodiment.

FIG. 8 is a graph showing temporal change in the rubbing detecting index according to the first embodiment.

FIG. 9 is a diagram illustrating an AE signal and a noise signal according to a second embodiment for individual frequency components.

FIG. 10 is a graph showing temporal distribution of a first order component of rotational speed extraction phase of an AE signal that has been subjected to a filter process using a first bandpass filter according to the second embodiment.

FIG. 11 is a graph showing temporal distribution of a first order component of rotational speed extraction phase of an AE signal that has been subjected to a filter process using a third bandpass filter according to the second embodiment.

FIG. 12 is a graph showing temporal distribution of a first order component of rotational speed extraction phase of an AE signal that has been subjected to a filter process using a fifth bandpass filter according to the second embodiment.

### DESCRIPTION OF EMBODIMENTS

### First Embodiment

Below, embodiments of the disclosure will be described in detail with reference to the drawings. The embodiments described below deal with a case where a rotary machine is a steam turbine, but the rotary machine according to the disclosure is not limited to a steam turbine.

FIG. 1 is a block diagram illustrating the configuration of a rubbing detection device 100 for a rotary machine according to the present embodiment. FIG. 1 illustrates a steam turbine as a rotary machine 10. Note that the rotary machine 10 is not limited to a steam turbine and can may be any type of rotary machine such as a gas turbine or a compressor. The rotary machine 10 according to the present embodiment includes a rotating shaft 30 that has a plurality of rotor blades 32 arranged on the rotating shaft 30 and is supported at either end by bearing portions 20 serving as fixed portions, and a casing 40 having a plurality of stator blades 44 arranged in the casing 40. The rotor blades 32 and the stator blades 44 are disposed alternately on a line-by-line basis and accommodated in the casing 40. An AE sensor 110 of the rubbing detection device 100 is attached to the bearing portion 20.

Steam, which is a working fluid W that has flowed in from an inflow port 42 of the casing 40, passes by the rotor blades 32 arranged on the rotating shaft 30 inside the casing 40. This steam acts on the rotor blades 32 to impart rotational force to the rotating shaft 30. The stator blades 44 arranged in the casing 40 regulate the flow of steam. The steam that has passed by the rotor blades 32 flows out from an outflow port 46.

### Rubbing Detection Device

As illustrated in FIG. 1, the rubbing detection device 100 includes the AE sensor 110, a rotational speed meter 112, an input-output unit 120, a recording unit 130, and a control unit 140. The AE sensor 110 and the rotational speed meter 112 are connected to the input-output unit 120. The input-output unit 120 and the recording unit 130 are each connected to the control unit 140. The rubbing detection device 100 is configured as a PC and includes, in the input-output unit 120, a display monitor and a keyboard that are not illustrated.

The AE sensor 110 is configured as a sensor for detecting acoustic emission (AE; high-frequency output), and outputs a detected AE wave as an AE signal S. The AE sensor 110 is mounted to the bearing portion 20 and is connected to the input-output unit 120.

The rotary machine 10 generates the AE wave when, for example, a seal or the like attached to the casing 40 that has thermally deformed rubs with the rotating shaft 30. For example, the AE wave generated at a portion R where rubbing occurs propagates through the surface of the rotating shaft 30 as an elastic wave and is detected by the AE sensor 110 through the bearing portions 20. The AE wave typically has a frequency that falls in a sound-wave region ranging from several tens of kHz to several MHz. The AE signal S acquired by the AE sensor 110 contains the frequency of the AE wave generated as a result of rubbing and the frequency of a noise signal N resulting from steam flow and so on.

The AE sensor 110 includes an element that detects vibration of the AE wave and outputs the vibration as a voltage, and an amplifier that amplifies the voltage output from the element and outputs the amplified voltage as an electrical signal. The AE sensor 110 is configured integrally with the rubbing detection device 100 in the present embodiment. However, the AE sensor 110 may be configured as a standalone sensor device.

The rotational speed meter 112 detects the rotational speed of the rotating shaft 30 to output a rotational speed f to the input-output unit 120. The rotational speed meter 112 includes, for example, a dog attached to the rotating shaft 30, and a detector that detects the dog. The rotating shaft 30 rotates one turn and the dog is input once to the rotational speed meter 112. Then, the rotational speed meter 112 outputs the rotational speed f based on the input. The rotational speed f output from the rotational speed meter 112 is synchronized with the AE signal S and acquired from the control unit 140. The rotational speed meter 112 may also be configured such that output is performed to the AE sensor 110 and the output is obtained by the control unit 140 from the input-output unit 120 via the AE sensor 110.

The input-output unit 120 notifies the control unit 140 of the AE signal S input from the AE sensor 110 and the rotational speed f of the rotating shaft 30 output from the rotational speed meter 112. The AE signal S and the rotational speed f are recorded as data in the recording unit 130. In a case where the AE sensor 110 is configured as a single unit, the AE sensor 110 may be configured such that information can be input to or output from a recording medium such as a USB memory, so that the information is input to or output from the AE sensor 110 and the rotational speed meter 112 through the recording medium. The input-output unit 120 includes a keyboard, a mouse, and a display monitor, which are not illustrated.

The recording unit 130 holds programs and data. The recording unit 130 is configured, for example, as a hard disk drive (HDD).

The control unit 140 uses programs and data recorded in the recording unit 130 to perform a predetermined computing process on the AE signal S input from the AE sensor 110. The control unit 140 includes a signal acquisition unit 142, a filter processing unit 144, a data processing unit 156, a rotation-synchronization-component calculation unit 158, an index calculation unit 160, a threshold value calculation unit 162, and a determination unit 164. The control unit 140 includes a central processing unit (CPU) and executes various types of computing processes using the CPU to perform functions of each of the units.

The signal acquisition unit 142 acquires the AE signal S from the AE sensor 110. The signal acquisition unit 142 executes a program recorded in the recording unit 130 to acquire the AE signal S from the AE sensor 110. The AE signal S acquired by the signal acquisition unit 142 is recorded as data in the recording unit 130. The AE signal S is acquired at predetermined intervals. For example, the AE signal S is acquired at an interval of once every several seconds. At a single data acquisition, the signal acquisition unit 142 acquires data during a period of time in which the rotating shaft rotates two rotations to four rotations.

The filter processing unit 144 executes a program recorded in the recording unit 130 to perform a filter process on the AE signal 5, and outputs an AE signal Sf that has been subjected to the filter process. The filter processing unit 144 includes a filter with a predetermined frequency component being set as a passband. The passband of the filter in the filter processing unit 144 includes any of frequency bands ranging from several tens of kHz to several MHz, which corresponds to a frequency component included in the AE signal S.

The filter processing unit 144 according to the present embodiment includes a bandpass filter with a plurality of different frequency bands being set as a passband. The filter processing unit 144 according to the present embodiment includes a first bandpass filter 146, a second bandpass filter 148, a third handpass filter 150, a fourth handpass filter 152, and a fifth handpass filter 154. The first bandpass filter 146 is a filter having a passband ranging from 75 kHz to 100 kHz. The second handpass filter 148 is a filter having a passband ranging from 100 kHz to 125 kHz. The third bandpass filter 150 is a filter having a passband ranging from 125 kHz to 150 kHz. The fourth bandpass filter 152 is a filter having a passband ranging from 150 kHz to 175 kHz. The fifth bandpass filter 154 is a filter having a passband ranging from 175 kHz to 200 kHz. The bandpass filter is a filter that reduces components other than the passband by a predetermined ratio, for example, by 90% or more. In addition, it is only necessary that the filter processing unit 144 is able to perform a filter process on the AE signal S with frequency used as a reference. The filter processing unit 144 may employ a low-pass filter that only passes frequency components at or below a predetermined frequency, and a high pass filter that only passes frequency components at or above a predetermined frequency.

The data processing unit 156 executes a program recorded in the recording unit 130 to perform a predetermined envelope process, re-sampling, and an average-value zero process on the AE signal S or the AE signal Sf that has been subjected to the filter process. In the envelope process, an envelope process is performed on the AE signal S or the AE signal Sf to output an AE signal Sr in which a high-frequency component is removed. In the re-sampling process, re-sampling at a predetermined frequency is performed on the AE signal Sr that has been subjected to the envelope process to output an AE signal Sp that has been subjected to re-sampling. In the average-value zero process, a process of zeroing an average is performed on the AE signal S. This average value is an average of amplitudes in each cycle and serves as a synchronous average. After the process, an AE signal Sz that has been subjected to the average-value zero process is output.

The rotation-synchronization-component calculation unit 158 executes a program recorded in the recording unit 130 to perform frequency analysis on the AE signal Sz. The rotation-synchronization-component calculation unit 158 performs frequency analysis to convert the AE signal Sz, which is a time series function, into a frequency function expressed as amplitude for each frequency, and outputs a rotational-order analysis result F in which frequency is expressed in terms of rotational orders (FIG. 2) The rotational order represents an order in which a frequency component corresponding to the rotational speed f of the rotating shaft 30 is set as one. Here, a first order component of the rotational speed C has a frequency component of which rotational order output by the rotation-synchronization-component calculation unit 158 is 1.

The index calculation unit 160 executes a program recorded in the recording unit 130 to calculate a rubbing detecting index D for information relating to a phase of the AE signal S. The rubbing detecting index D is determined as a temporal distribution, as illustrated in FIG. 3. The rubbing detecting index D is calculated using the following Equation (1).

Rubbing detection index=1/(1+(dispersion of phase of AE signal)\hat{ }0.5) (1)

For example, the dispersion of phase of the first order component of the rotational speed C is used to calculate the rubbing detecting index D. Specifically, the dispersion of phase of the first order component of the rotational speed C is determined as the dispersion of a first order component of the rotational speed extraction phase P obtained by performing predetermined sampling on a phase of the first order component of the rotational speed C. The first order component of the rotational speed extraction phase P is acquired by using, as a phase, shift of the cycle of the first order component of the rotational speed C with respect to the cycle of the rotational speed f acquired by the rotational speed meter 112. The first order component of the rotational speed extraction phase P is acquired by, for example, performing sampling of five to ten rotational points at intervals of several seconds.

The threshold value calculation unit 162 executes a program recorded in the recording unit 130 to acquire a threshold value T used to determine the presence or absence of rubbing in terms of the rubbing detecting index D. The threshold value T is calculated from, for example, cumulative probability of the rubbing detecting index D in a state where rubbing does not occur, as illustrated in FIG. 4. The threshold value T may be calculated, for example, in a manner such that cumulative probability is given in advance, and the rubbing detecting index D that meets this cumulative probability is calculated as the threshold value. For the threshold value T, for example, the rubbing detecting index D may be given in advance. That is, for example, in the example illustrated in FIG. 4, a cumulative probability of 99.7% is given in advance, and the rubbing detecting index D of 0.034 calculated based on this value may be used as the threshold value T. Alternatively, for example, the threshold value T of 0.034 may be given in advance.

The determination unit 164 executes a program recorded in the recording unit 130 to determine the presence or absence of rubbing in terms of the rubbing detecting index D. The presence or absence of rubbing is determined by comparing the rubbing detecting index D with the threshold value T. The determination unit 164 may be configured so as to output the presence of rubbing, for example, on a display monitor in a case where the rotary machine 10 is determined to have rubbing. The time at which the rubbing detecting index D is detected to exceed the threshold value T can be estimated as a time of occurrence of rubbing. The determination unit 164 may be configured, for example, so as to output the presence of rubbing to the rotary machine 10 to provide feedback in a case where it is determined that rubbing is occurring in the rotary machine 10.

### Method for Detecting Rubbing

Next, a method for detecting rubbing of a rotary machine will be described. As illustrated in FIG. 5, a method for detecting rubbing according to the present embodiment includes Step S10 of acquiring an AE signal, Step S20 of performing a filter process, Step S30 of performing data processing, Step S40 of calculating a rotation-synchronization component, Step S50 of calculating a rubbing detecting index, Step S60 of calculating a threshold value, and Step S70 of determining the presence or absence of rubbing. In the method for detecting rubbing, the rubbing detecting index D may be calculated by performing Step S30 of performing data processing and subsequent steps on the AE signal S without performing Step S20 of performing the filter process. Below, with reference to the flowchart illustrated in FIG. 5, description will be made of each of the steps that constitute the method for detecting rubbing according to the present embodiment.

The rubbing detection device 100 acquires the AE signal S (Step S10). The rubbing detection device 100 uses the signal acquisition unit 142 to acquire the AE signal S.

The rubbing detection device 100 performs a filter process using a predetermined filter on the acquired AE signal S to output the AE signal Sf that has been subjected to the filter process so as to have a frequency component in connection with the passband of the filter (step S20). The filter process is performed by using a bandpass filter having a predetermined frequency band of the AE signal S being set as a passband. The rubbing detection device 100 performs the filter process by using the filter processing unit 144.

The rubbing detection device 100 performs the envelope process, the re-sampling, and the average-value zero process on the AE signal S or the AE signal Sf that has been subjected to the filter process, to thereby perform data processing (Step S30). In the envelope process, the rubbing detection device 100 performs the envelope process on the AE signal Sf that has been subjected to the filter process or the AE signal S, and outputs the AE signal Sr that has been subjected to the envelope process. In the re-sampling process, the rubbing detection device 100 performs re-sampling on the AE signal Sr that has been subjected to the envelope process, and outputs the AE signal Sp that has been subjected to the re-sampling process. In the average-value zero process, the rubbing detection device 100 performs, on the AE signal Sp that has been subjected to re-sampling, a process of zeroing the average value of the amplitude in each cycle, and outputs the AE signal Sz that has been subjected to the average-value zero process. The rubbing detection device 100 performs the data processing by using the data processing unit 156.

The rubbing detection device 100 performs frequency analysis on the AE signal Sz that has been subjected to the average-value zero process, and outputs the rotational-order analysis result F in which frequency is expressed in terms of rotational orders, as illustrated in FIG. 2 (Step S40). FIG. 2 is a graph showing the amplitude of the AE signal according to the first embodiment for each rotational order. The rubbing detection device 100 calculates a rotation-synchronization component by using the rotation-synchronization-component calculation unit 158.

The rubbing detection device 100 acquires the first order component of the rotational speed C based on the rotational-order analysis result F, and calculates the rubbing detecting index D in terms of the first order component of the rotational speed extraction phase P acquired by performing sampling of the first order component of the rotational speed C (Step S50). The rubbing detection device 100 performs the index calculation by using the index calculation unit 160.

Next, the rubbing detection device 100 calculates the threshold value T for the calculated rubbing detecting index D (Step S60). The rubbing detection device 100 performs threshold calculation by using the threshold value calculation unit 162.

The rubbing detection device 100 determines the presence or absence of rubbing in terms of the calculated rubbing detecting index D (Step S70). The rubbing detection device 100 determines the presence or absence of rubbing by comparing the calculated rubbing detecting index D with the threshold T. When the rubbing detecting index D exceeds the threshold value T, the rubbing detection device 100 determines that rubbing exists (YES in Step S70). When the rubbing detecting index D is less than or equal to the threshold value T, the rubbing detection device 100 determines that rubbing does not exist (NO in Step S70). The rubbing detection device 100 makes the determination by using the determination unit 164.

### Second Embodiment

In a case where the filter processing unit 144 includes a plurality of filters as in the present embodiment, the rubbing detection device 100 performs the processes of Step S20 to Step S70 in parallel for each of the filters. The rubbing detection device 100 outputs the AE signal Sf processed by each of the filters in Step S20, and performs processing on each AE signal Sf.

In a case where, for example, there are N filters, the rubbing detection device 100 outputs N pieces of AE signals Sf that have been subjected to the filter process (Step S20). The rubbing detection device 100 performs data processing on the N pieces of AE signals Sf that have been input, and outputs N pieces of AE signals Sp that have been subjected to re-sampling (Step S30). The rubbing detection device 100 performs frequency analysis on the N pieces of input AE signals Sz, and outputs N pieces of rotational-order analysis results F (Step S40). The rubbing detection device 100 acquires the first order component of the rotational speed extraction phase P based on the N pieces of inputted rotational order analysis results F, and calculates N pieces of rubbing detection indices D (Step S50). The rubbing detection device 100 calculates N pieces of threshold values T for the N pieces of input rubbing sensing indices D (Step S60). For the N pieces of input rubbing sensing indices D and the N pieces of input threshold values T, the rubbing detection device 100 compares each of the rubbing sensing indices D and threshold values T corresponding to the rubbing sensing indices D. When any of the rubbing sensing indices D exceeds the corresponding threshold value T, the rubbing detection device 100 determines that rubbing exists (YES in Step 70). When all the rubbing sensing indices D are less than or equal to the corresponding threshold value T, the rubbing detection device 100 determines that no rubbing exists (NO in Step S70).

In a case where the filter process is not performed in the method for detecting rubbing described above, the rubbing detection device 100 performs the envelope process and subsequent steps on the AE signal 5, and outputs the AE signal Sz that has been subjected to data processing. That is, in the envelope process, the rubbing detection device 100 performs the envelope process on the AE signal S that has not been subjected to the filter process, and outputs the AE signal Sr that has been subjected to the envelope process. In the re-sampling process, the rubbing detection device 100 performs re-sampling on the AE signal Sr that has been subjected to the envelope process, and outputs the AE signal Sp that has been subjected to the re-sampling process. In the average-value zero process, the rubbing detection device 100 performs, on the AE signal Sp that has been subjected to the re-sampling, a process of zeroing the average value of the amplitude in each cycle, and outputs the AE signal Sz that has been subjected to the average-value zero process.

### Calculation of Rubbing Detecting Index

With reference to FIGS. 6 to 8, description will be made of a process of calculating the rubbing detecting index D based on the AE signal acquired from a rotary machine in which rubbing has occurred. FIG. 6 is a graph showing temporal change in amplitude of shaft vibration when rubbing occurs in a rotary machine. The vertical axis of the graph illustrated in FIG. 6 represents the amplitude of the shaft vibration detected at the bearing, and the horizontal axis represents time. The reference sign V1 in FIG. 6 indicates vibration data on the rotating shaft acquired from a vibration meter permanently installed on the bearing that supports one end of the two ends of the rotating shaft of the rotary machine. The reference sign V2 indicates vibration data on the rotating shaft acquired from a vibration meter installed on the bearing that supports the other end of the two ends of the rotating shaft of the rotary machine. In addition, FIGS. 7 and 8 illustrate data of the AE signal acquired at this time using the AE sensor from the same rotary machine. FIG. 7 is a graph showing temporal change in the first order component of the rotational speed extraction phase R FIG. 8 is a graph showing temporal change in the rubbing detecting index D.

From FIG. 6, it is understood that an uplift takes place in V2 just before 10:30. In FIG. 6, V2 then increases with time, and the shaft vibration reaches a vibration threshold value at around 11:10. V1 also increases with time from a time just before 10:30, which is almost the same time when a change happens in V2, and the shaft vibration reaches a vibration threshold value at around 11:20. Here, when the shaft vibration reaches the vibration threshold value, the rotary machine illustrated in FIG. 6 stops operating.

FIG. 7 is a graph of temporal change in the distribution of the first order component of the rotational speed extraction phase P in the case described above. From FIG. 7, it can be seen that most of the first order component of the rotational speed extraction phases P gather at approximately 60° after 10:35. In addition, a tendency can be seen from around 10:15 to around 10:25 that the first order component of the rotational speed extraction phases P gather at approximately 60°.

FIG. 8 shows temporal distribution of the rubbing detecting index D in the case described above. In FIG. 8, a rubbing detecting index D that exceeds the threshold value T occurs at around 10:20. Thus, it can be estimated that rubbing occurs at around 10:20. In contrast, in the data on the shaft vibration acquired using the vibration meter illustrated in FIG. 6, sign of an increase in shaft vibration first appears just before 10:30. As described above, it is possible to detect the occurrence of rubbing from the rubbing detecting index D based on the phase of the AE signal S. Thus, it is understood that, by using the rubbing detecting index D, it is possible to detect the occurrence of rubbing at an earlier timing than that at which shaft vibration increases. In addition, by performing determination with a threshold value being set for the rubbing detecting index D, the occurrence of rubbing can be detected in a mechanical manner.

Furthermore, in the case described above, the signal-to-noise ratio between the AE signal due to rubbing and the noise signal at 10:20, which is the time at which detection is made based on the rubbing detecting index D, was approximately −10 dB. Here, the signal-to-noise ratio is determined as: signal-to-noise ratio=10·log₁₀ ((amplitude of AE signal Sr after the envelope process)/(amplitude of noise signal N after the envelope process)). In addition, the noise signal N due to steam entering the rotary machine is included between 10:30 and 11:15. However, as illustrated in FIG. 7, the distribution of the first order component of the rotational speed extraction phases P tends to converge even between 10:30 and 11:15, and no influence of the noise signal due to steam entering the rotary machine can be seen. As described above, with the method for detecting rubbing, using the rubbing detecting index D based on the first order component of the rotational speed extraction phase P based on the phase of the AE signal makes it possible to detect rubbing earlier than detection using shaft vibration, even in an environment where many noise signals exist such as in a steam turbine.

Next, with reference to FIGS. 9 to 12, description will be made of a case in which a plurality of bandpass filters is used. First, the relationship between the filter and the signal-to-noise ratio will be described. FIG. 9 illustrates the AE signal S of rubbing and the noise signal N for each frequency component. A noise occurring when steam flows into the steam turbine causes an increase in the amplitude of the noise signal N from 50 kHz to 120 kHz. In addition, the AE signal S of rubbing shows peaks formed at 75 kHz and 175 kHz. The signal-to-noise ratio between the AE signal S of rubbing and the noise signal N was −14.0 dB at a frequency component of 75 kHz.

In contrast, the signal-to-noise ratio between the AE signal S of rubbing and the noise signal N was −3.4 dB at a frequency component of 175 kHz. In this case, in order to detect rubbing using the rubbing detecting index D in a more accurate manner, it is preferable to use a frequency component of 175 kHz exhibiting a lower signal-to-noise ratio. Thus, a frequency component including 175 kHz of the AE signal S is acquired as the AE signal Sf by performing a filter process on the AE signal using a bandpass filter having a frequency band of 175 kHz being set as a passband thereof. In this way, in an actual rotary machine, the signal-to-noise ratio between the AE signal S of rubbing and the noise signal N may vary depending on which frequency component is looked at in the AE signal S of rubbing. This leads to a need for performing a filter process with a filter having an appropriate passband.

With reference to FIGS. 10 to 12, description will be made of a difference in the distribution of the first order component of the rotational speed extraction phase P of the AE signal Sf in a case where a filter process is performed on the AE signal S using bandpass filters having a plurality of different frequency components being set as a passband. FIG. 10 is a graph showing temporal distribution of the first order component of the rotational speed extraction phase P of the AE signal Sf obtained by performing a filter process on the AE signal S using the first bandpass filter 146. FIG. 11 is a graph showing temporal distribution of the first order component of the rotational speed extraction phase P of the AE signal Sf obtained by using the third bandpass filter 150 to perform a filter process on the AE signal S that is the same as the AE signal S in FIG. 10. FIG. 12 is a graph showing temporal distribution of the first order component of the rotational speed extraction phase P of the AE signal Sf obtained by using the fifth bandpass filter 154 to perform a filter process on the AE signal S that is the same as the AE signal SF in FIGS. 10 and 11.

In FIG. 10, no tendency of convergence of the first order component of the rotational speed extraction phases P can be seen at any time, and the first order component of the rotational speed extraction phases P spread in an almost uniform manner. However, in FIG. 11, it can be understood that there is a tendency that the distribution of most of the first order component of the rotational speed extraction phases P converges at and after 3500 seconds in a range from 30° to 120°. In addition, in FIG. 12, it can be understood that there is a strong tendency that the distribution of most of the first order component of the rotational speed extraction phases P converges at and after approximately 3000 seconds in a range from 45° to 90°. By obtaining the rubbing detecting index D based on the AE signal SF that has been subjected to the filter process, it is possible to detect the presence or absence of rubbing.

As described above, in order to obtain the frequency component in connection with rubbing on the basis of the acquired AE signal 5, it is necessary to perform the filter process to the AE signal S using a bandpass filter having, as a passband thereof, a frequency band having a high signal-to-noise ratio, in other words, a frequency band having a high sensitivity to the AE signal S due to rubbing. However, there may be a case in which a frequency band having a high signal-to-noise ratio cannot be identified in advance. In addition, a frequency band having a high signal-to-noise ratio may also change. In such cases, by providing a bandpass filter having a plurality of different frequency components being set as a passband thereof, it is possible to perform a filter process to the AE signal in passbands including a plurality of different frequency components. This makes it possible to detect the presence or absence of rubbing using the rubbing detecting index D without being influenced by the noise signal N occurring due to usage conditions or usage situations of the rotary machine 10.

### Other Embodiments

The rubbing detection device for a rotary machine according to the first embodiment may be configured such that the determination unit 164 outputs a result of determination, for example, to a display monitor through the input-output unit 120, or outputs a feedback to the rotary machine 10. In addition, in the second embodiment, Step S70 of making a determination may include an output step in which a result of determination as to the presence or absence of rubbing of the rotary machine 10 is outputted from the input-output unit 120 to display it, for example, on a monitor, or may include a feedback step in which a feedback is given from the input-output unit 120 to the rotary machine to perform output.

While preferred embodiments of the invention have been described as above, it is to be understood that variations and modifications will be apparent to those skilled in the art without departing from the scope and spirits of the invention. The scope of the invention, therefore, is to be determined solely by the following claims.

1. A rubbing detection device for a rotary machine, comprising:
an AE sensor disposed at a fixed portion of a rotary machine and configured to acquire an AE signal of the rotary machine;
a calculation unit configured to calculate a rubbing detecting index based on information relating to a phase of the AE signal, the rubbing detecting index relating to rotation of the rotary machine; and
a determination unit configured to determine presence or absence of rubbing from the rubbing detecting index.

2. The rubbing detection device for a rotary machine according to claim 1, wherein the rubbing detecting index includes a rubbing detecting index expressed as Equation (1).
Rubbing detection index=1/(1+(dispersion of phase of AE signal)\hat{ }0.5) (1)

3. The rubbing detection device for a rotary machine according to claim 1, the device further comprising:
a filter processing unit configured to perform a filter process on the AE signal, a frequency component corresponding to a rotational speed of the rotary machine being set as a passband,
wherein the filter processing unit inputs a processed signal to the calculation unit.

4. The rubbing detection device for a rotary machine according to claim 3, wherein the filter processing unit includes a bandpass filter.

5. The rubbing detection device for a rotary machine according to claim 4, wherein the filter processing unit includes a plurality of bandpass filters having a plurality of different frequency components being set as a passband.

6. The rubbing detection device for a rotary machine according to claim 5, wherein the plurality of bandpass filters having a plurality of different frequency components being set as a passband includes at least one of a bandpass filter having a frequency component of 75 kHz to 100 kHz as a passband, a bandpass filter having a frequency component of 100 kHz to 125 kHz as a passband, a bandpass filter having a frequency component of 125 kHz to 150 kHz as a passband, a bandpass filter having a frequency component of 150 kHz to 175 kHz as a passband, and a handpass filter having a frequency component of 175 kHz to 200 kHz as a passband.

7. A method for detecting rubbing of a rotary machine, the method comprising the steps of:
acquiring an AE signal of a rotary machine, this step being disposed on a fixing portion of a rotary machine;
calculating a rubbing detecting index for determining presence or absence of rubbing based on information relating to a phase of the AE signal, the rubbing detecting index relating to rotation of the rotary machine; and
determining presence or absence of rubbing in terms of the rubbing detecting index.

8. The method for detecting rubbing of a rotary machine according to claim 7, wherein the rubbing detecting index is expressed as Equation (1).
Rubbing detection index=1/(1+(dispersion of phase of AE signal)\hat{ }0.5) (1)

9. The method for detecting rubbing of a rotary machine according to claim 7, the method further comprising:
performing a filter process on the AE signal, a frequency component corresponding to a rotational speed of the rotary machine being set as a pass band.
